(19) United States
(12) Patent Application Publication
(10) Pub. No.: US 2014/0095403 A1
(43) Pub. Date: Apr. 3, 2014

(54) METHODS AND APPARATUS FOR MANAGING SAFETY INFORMATION

(71) Applicant: SIMS IP HOLDINGS, LLC, Wood Dale, IL (US)

(72) Inventor: Angelia Hopson, Hanover Park, IL (US)

(73) Assignee: SIMS IP HOLDINGS, LLC, Wood Dale, IL (US)

(21) Appl. No.: 13/631,306

(22) Filed: Sep. 28, 2012

(51) Int. Cl. G06Q 99/00

(52) U.S. Cl. 705/325

(57) ABSTRACT

Methods and apparatus for managing safety information are disclosed. In an embodiment, a computing device, or any other suitable device or system, receives employee identification information and associated job site location information (e.g., employee ID and job site location ID). The computing device then receives job site evaluation information including a selection from a user of a job site safety attribute that is associated with the job site (e.g., flammable materials present). The computing device also receives safety inspection information associated with the job site safety attribute (e.g., fire extinguishers in place). The computing device displays job site safety briefing information associated with the employee identification information and the job site safety attribute (e.g., employee warned about fire hazard). The computing device receives incident information associated with the employee identification information and the job site safety attribute (e.g., employee burned). The computing device then displays first aid information associated with the incident information (e.g., burn treatment).

### TECHNICAL FIELD

The present disclosure relates in general to job site safety, and, in particular, to methods and apparatus for managing safety information.

### BACKGROUND

Typically, employers are required to maintain certain health and safety standards at job sites and record information related to the safety of the job sites. For example, if a job site makes use of a hazardous material, proper handling equipment must be maintained, first-aid materials and equipment specific to that hazard may be needed, and employees may need to be informed or trained. If a safety incident occurs, (e.g., the hazardous material is spilled) additional information may need to be recorded and tracked.

Paper and computer based systems exist to record and track certain aspects of job site safety information. However, what is needed is a computerized system to manage a plurality of different job site safety aspects and integrate those aspects together in to one comprehensive system.

### BRIEF DESCRIPTION OF THE DRAWINGS

FIG. 1 is a block diagram of an example network communication system.

FIG. 2 is a block diagram of an example computing device.

FIG. 3 is a block diagram of an example apparatus for managing safety information.

FIG. 4 is a flowchart of an example process for managing safety information.

FIGS. 5-6 are example login screens.

FIG. 7 is an example user profile screen.

FIG. 8 is an example edit user profile screen.

FIG. 9 is an example manage attendance screen.

FIG. 10 is an example add new employee screen.

FIG. 11 is an example thank you screen.

FIG. 12 is an example job locations screen.

FIGS. 13-17 are example pre-work inspection screens.

FIG. 18 is an example pre-job safety briefing screen.

FIG. 19 is an example job safety analysis screen.

FIG. 20 is an example tool box meeting attendance screen.

FIGS. 21-23 are example preliminary site evaluation screens.

FIG. 24 is an example create incident screen.

FIG. 25 is an example manage incident screen.

FIGS. 26-27 are example first aid screens.

### DETAILED DESCRIPTION OF EXEMPLARY EMBODIMENTS

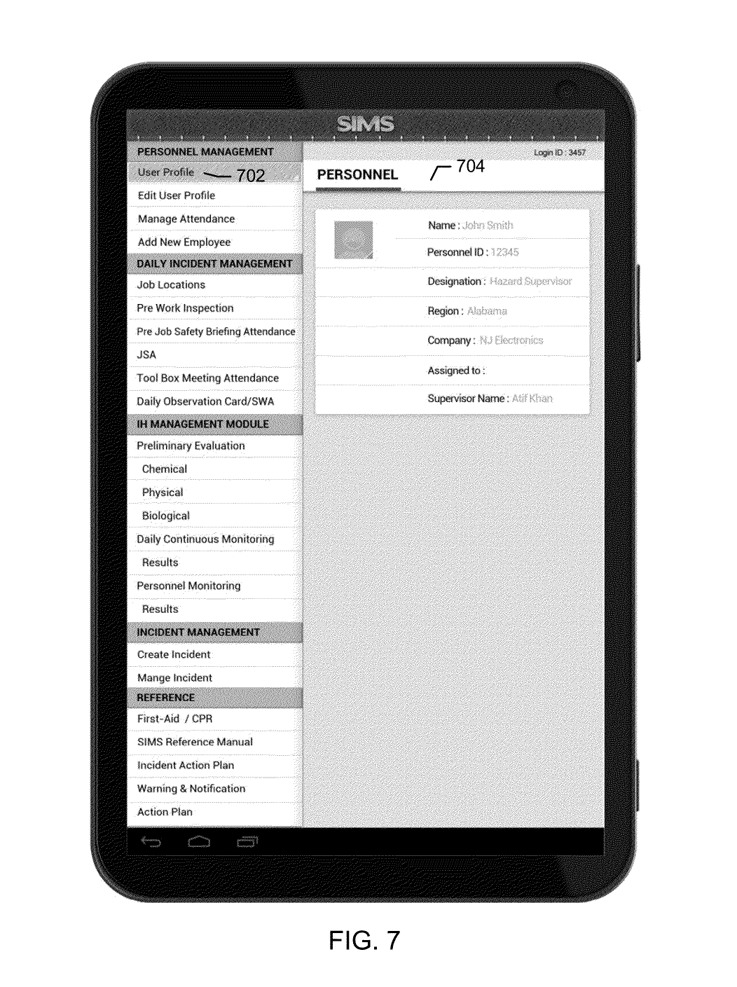

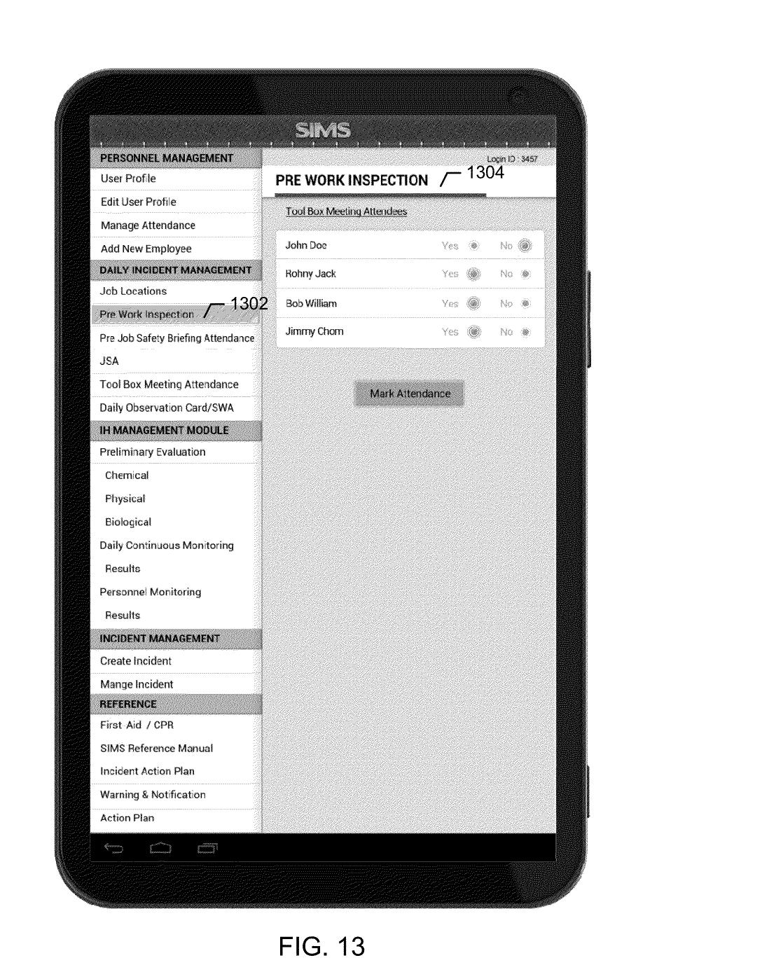

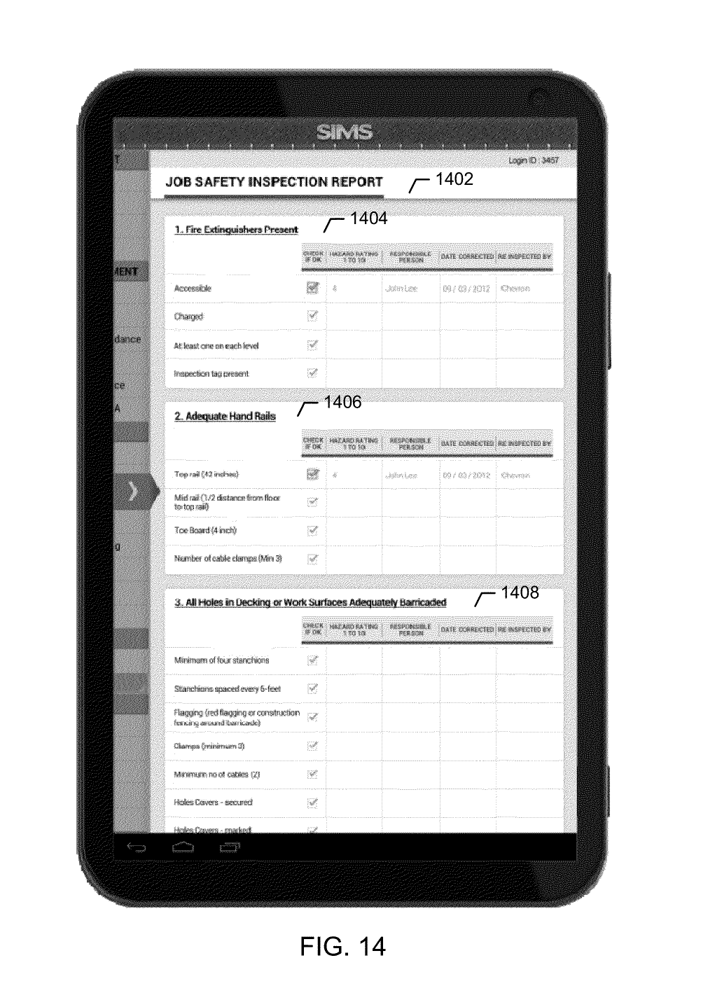

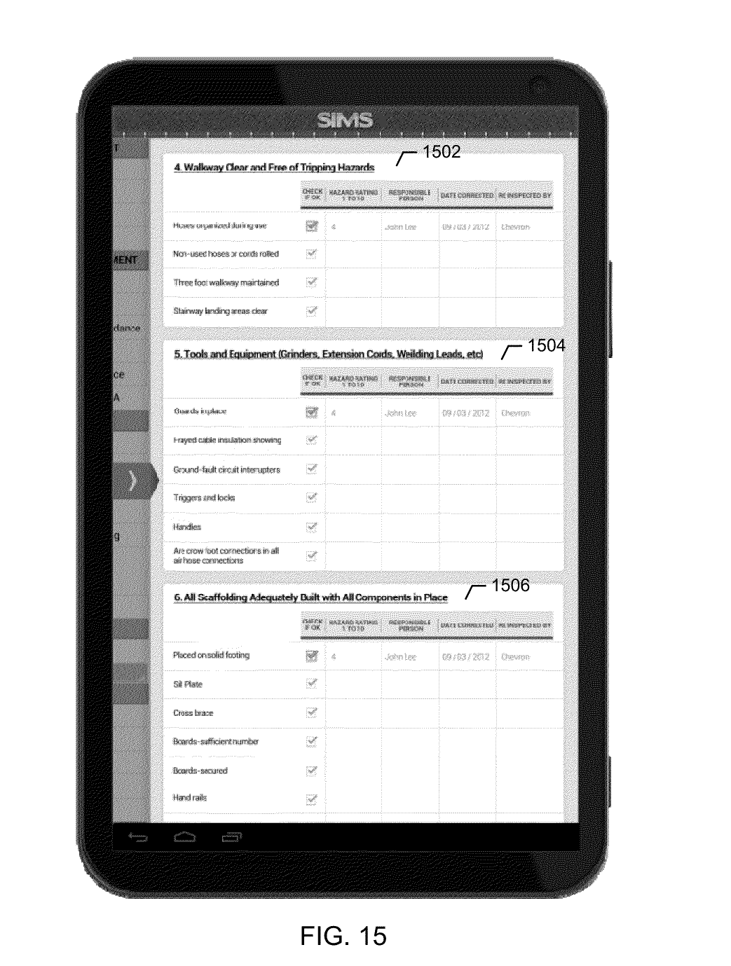

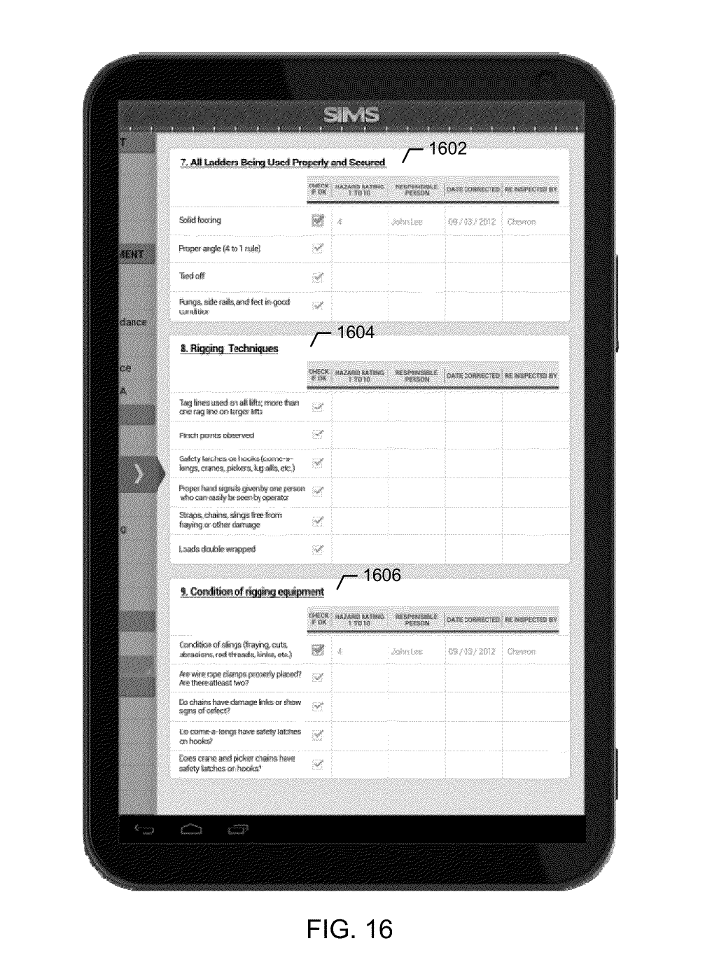

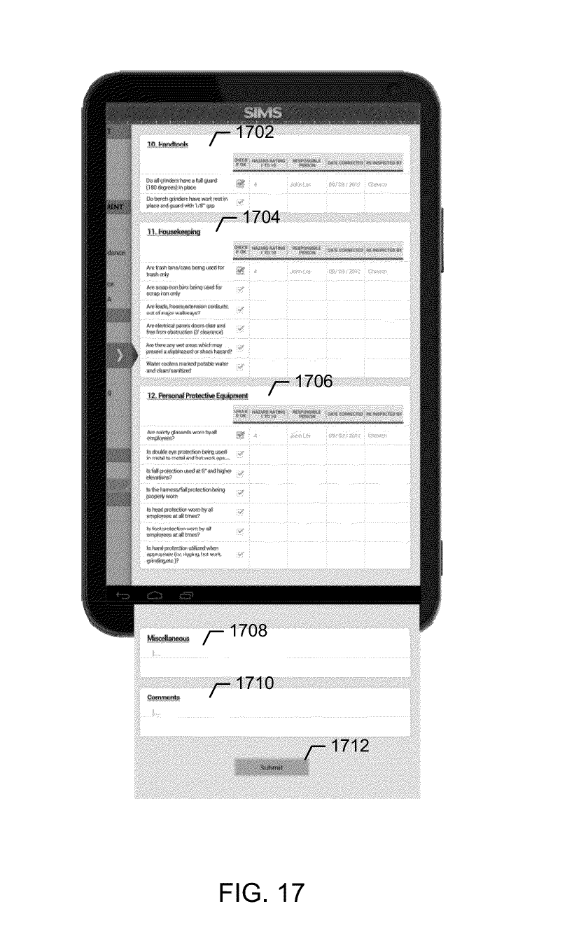

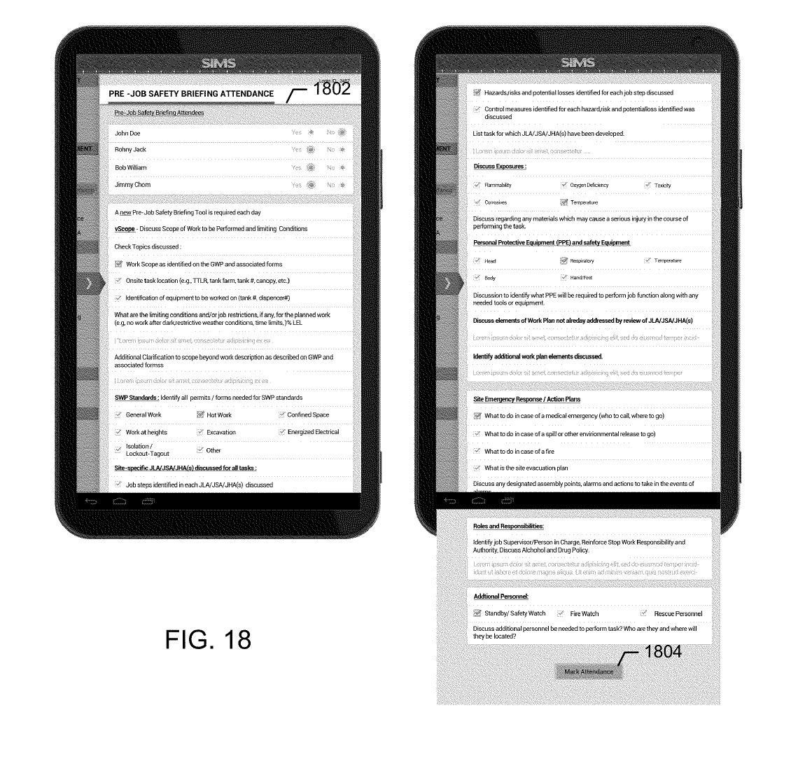

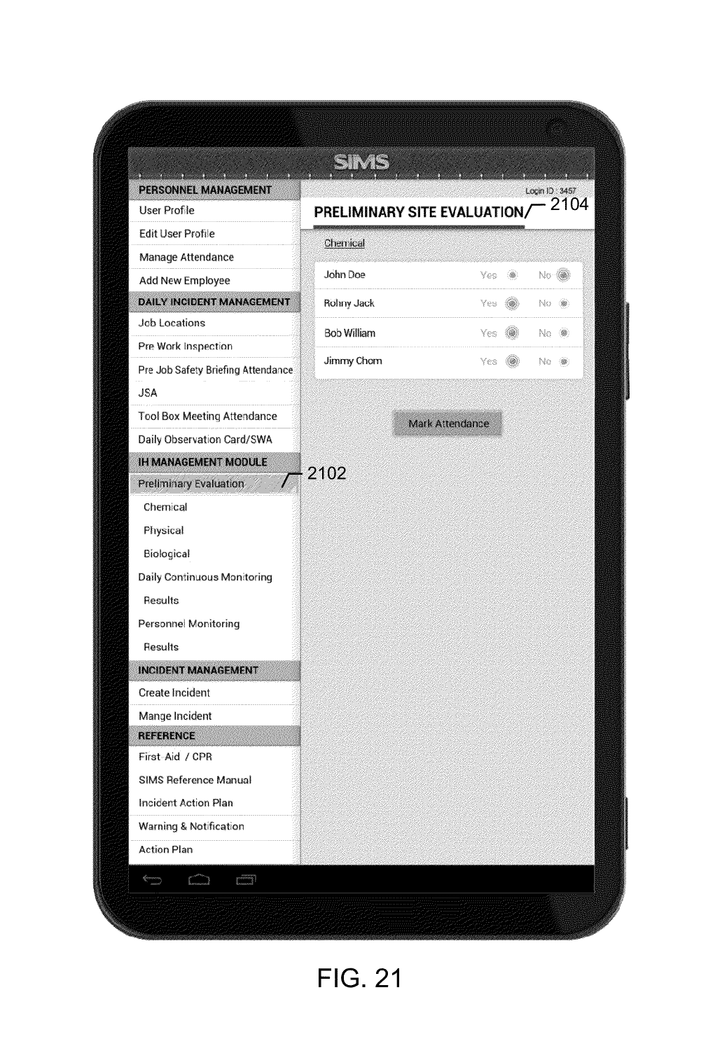

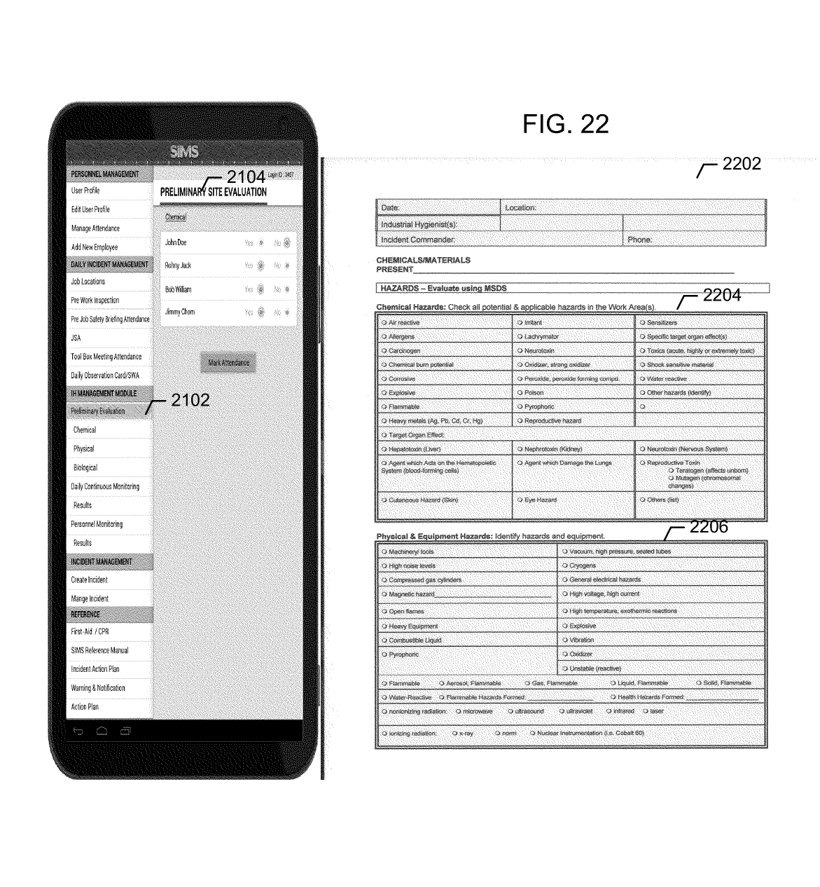

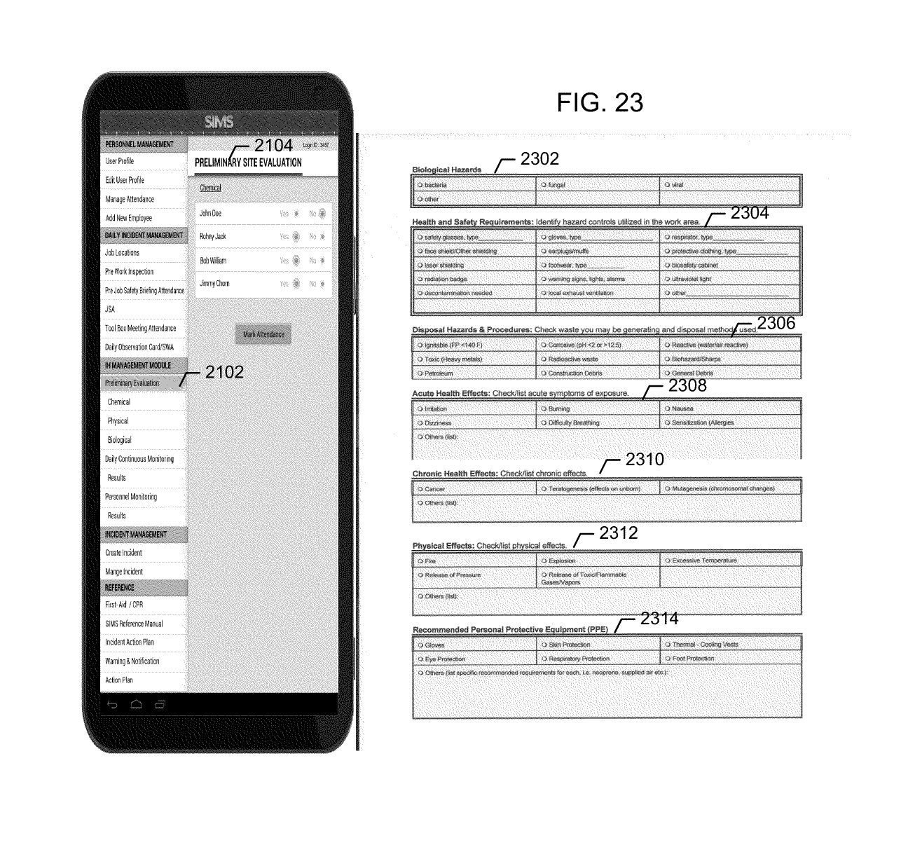

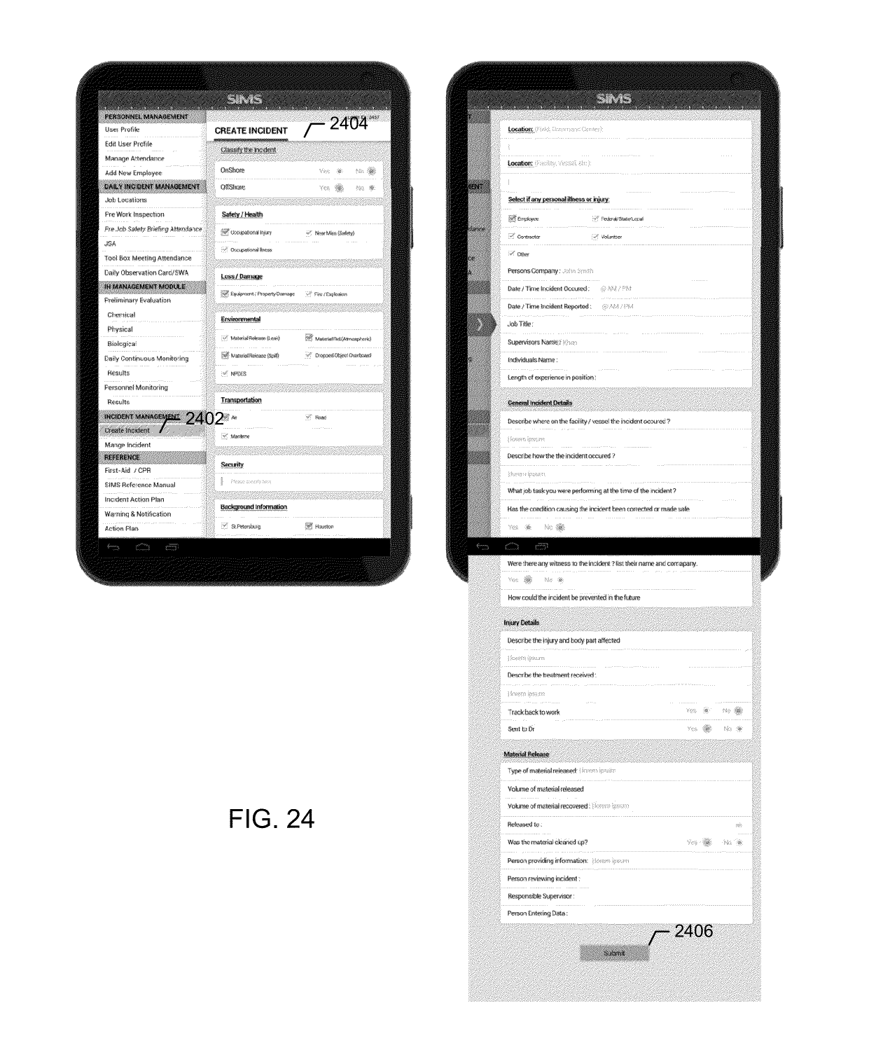

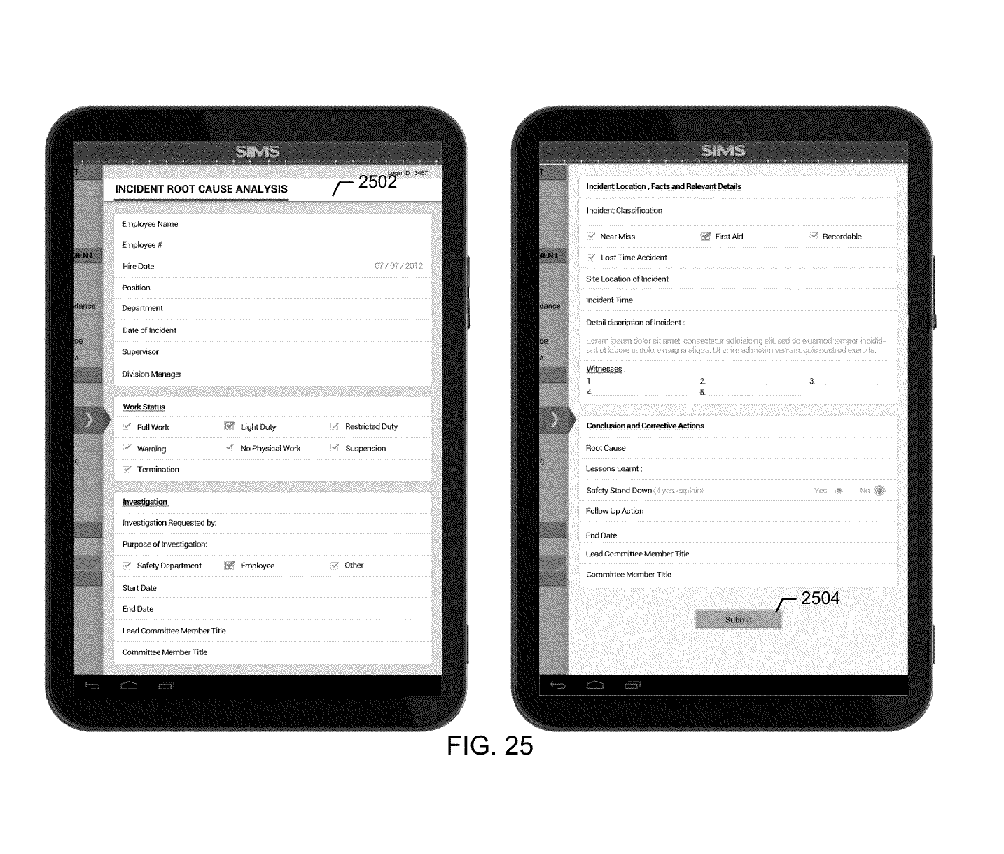

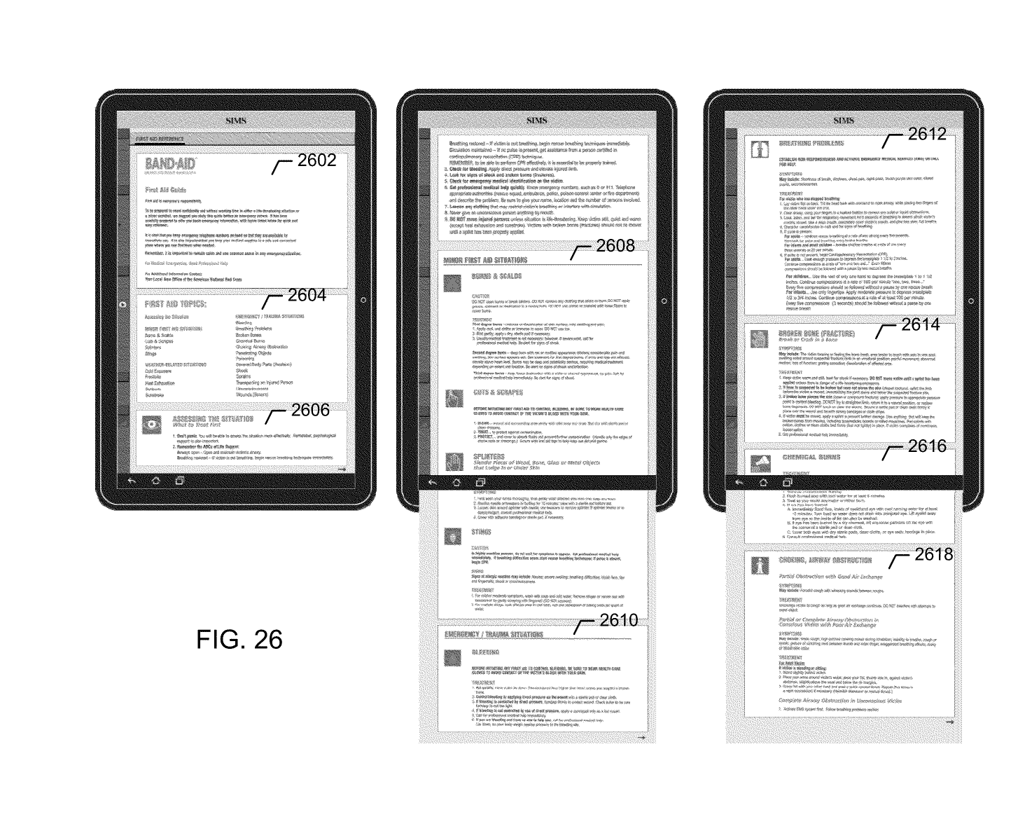

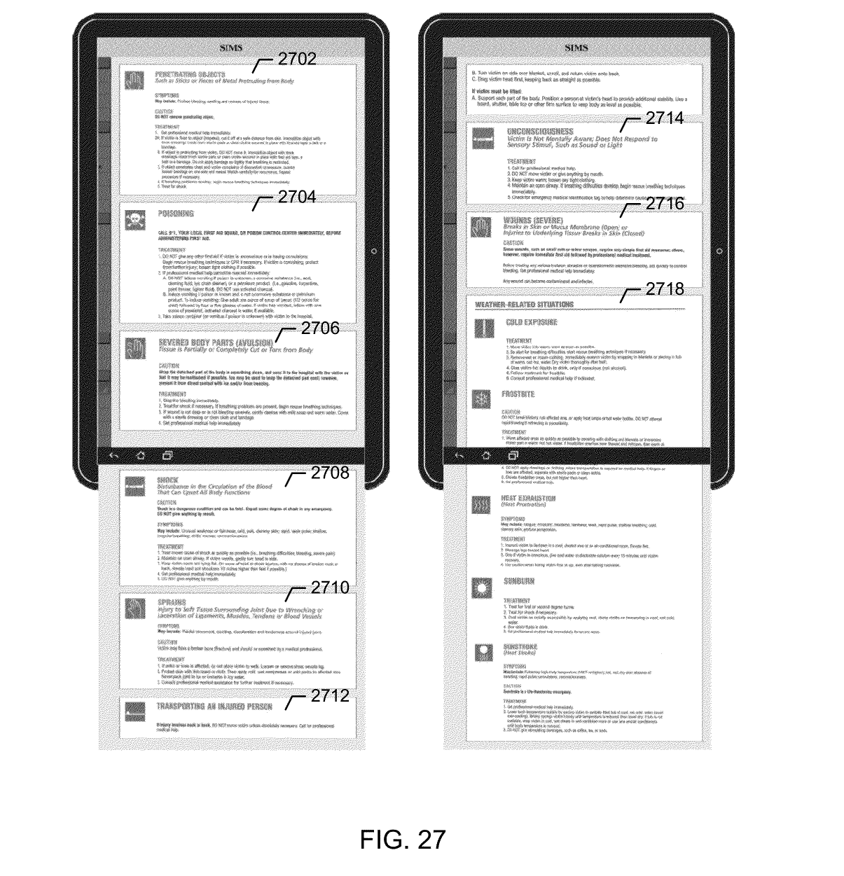

Briefly, methods and apparatus for managing safety information are disclosed. In an embodiment, an employee form (e.g., see FIGS. 7-12) is structured to receive employee identification information (e.g., name, personnel ID) and associated job site location information (e.g., city, state, building number). A job site evaluation form (e.g., see FIGS. 21-23) is structured to receive job site evaluation information including a selection from a user of a job site safety attribute that is associated with the job site (e.g., highly flammable materials are present). A safety inspection form (e.g., see FIGS. 13-17) is structured to receive safety inspection information associated with the job site safety attribute (e.g., are fire extinguishers properly placed and charged). A job site safety briefing form (e.g., see FIG. 18) is structured to display job site safety briefing information associated with the employee identification information and the job site safety attribute (e.g., warn employees about location of highly flammable materials). An incident form (e.g., see FIGS. 24-25) is structured to receive safety incident information associated with the employee identification information and the job site safety attribute (e.g., an employee was burned). A first aid page (e.g., see FIGS. 26-27) is structured to display first aid information associated with the incident information (e.g., how to treat the burn).

Among other advantages, the presently disclosed system collects and integrates information for each aspect of job site safety. These aspects include employee identification information, job site location information, job site evaluation information, safety inspection information, job site safety briefing information, safety incident information, and first aid information. The system facilitates incident management of real time data collection and analysis of responder health and safety information during an emergency response. Utilizing the system, site safety representatives can decrease the time gaps in sharing critical data to key incident command personnel, thereby expediting decisions, response plans and ensuring peace of mind for stakeholders. The system may also be used for daily data collection, regulatory reporting and compliance.

In one example, the employee form is structured to receive an employee picture and at least two of an employee name, an employee identification number, an employee email address, and an employee phone number. In one example, the employee form is structured to receive geographical location information selected from a map. In one example, the job site evaluation form is structured to receive safety hazard information associated with the job site. In one example, the job site evaluation form is structured to receive chemical information, physical information, and/or biological information. In one example, the safety inspection form is structured to receive equipment information associated with the job site safety attribute. In one example, the safety inspection form is structured to receive precaution information associated with the job site safety attribute. In one example, the job site safety briefing form is structured to display a plurality of safety checklists associated with the job site. In one example, the job site safety briefing form is structured to display equipment information associated with the job site safety attribute. In one example, the incident form is structured to display a plurality of checklists associated with the incident. In one example, the apparatus is further structured to generate a report associated with the incident information.

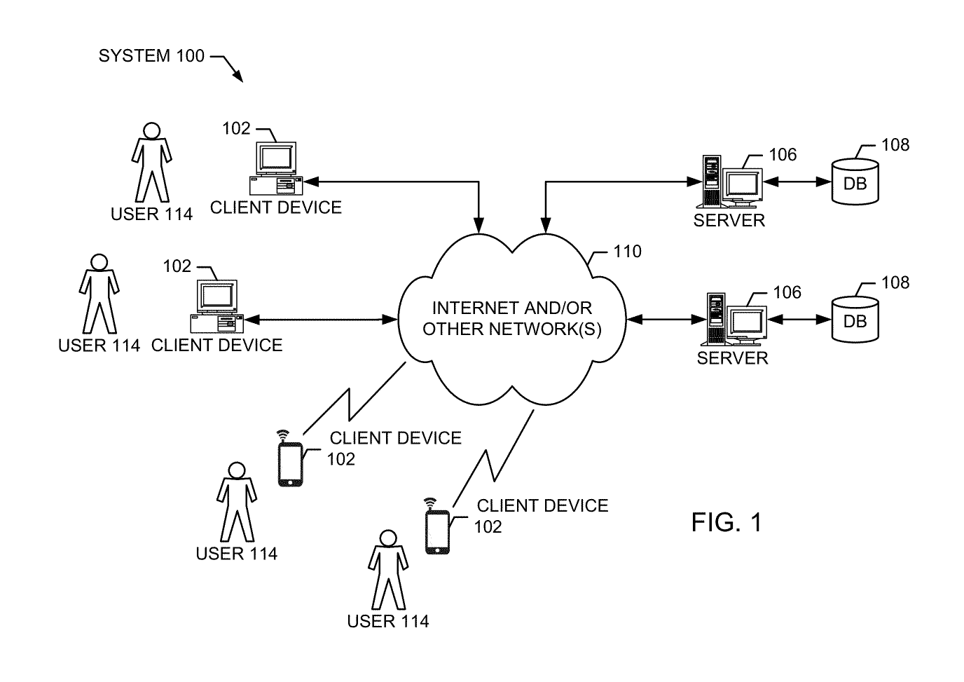

Turning now to the drawings, and as described in detail below, the present system is most readily realized in a network communications system, although any suitable communication system may be employed. A block diagram of an exemplary network communications system 100 is illustrated in FIG. 1. The illustrated system 100 includes one or more client devices 102, one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

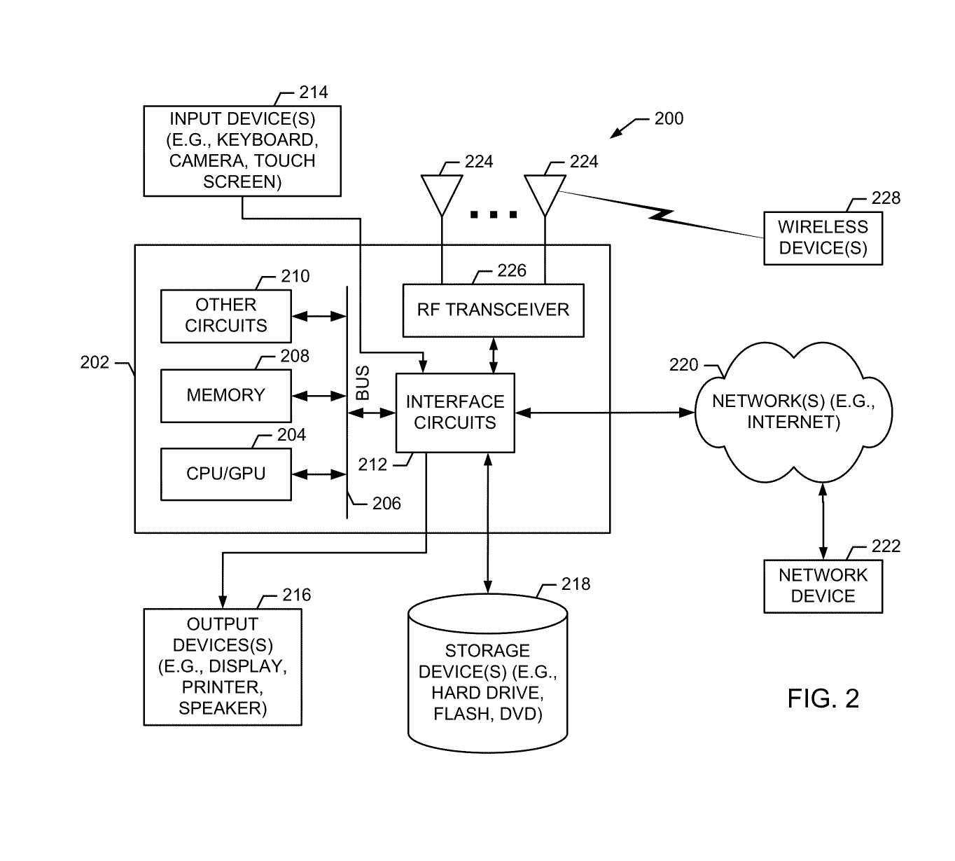

Each of the devices illustrated in FIG. 1 may include certain common aspects of many electronic devices such as microprocessors, memories, peripherals, etc. A detailed block diagram of the electrical systems of an example electrical device 200 is illustrated in FIG. 2. For example, the electrical device 200 may be a client, a server, a camera, a phone, and/or a television.

The example electrical device 200 includes a main unit 202 which may include, if desired, one or more processors 204 electrically coupled by an address/data bus 206 to one or more memories 208, other computer circuitry 210, and one or more interface circuits 212. The processor 204 may be any suitable processor or plurality of processors. For example, the electrical device 200 may include a central processing unit (CPU) and a graphics processing unit (GPU). The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processor 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, isopoint, camera and/or a voice recognition system.

One or more displays, printers, speakers, televisions, high definition televisions, and/or other suitable output devices 216 may also be connected to the main unit 202 via the interface circuit 212. The display 216 may be a cathode ray tube (CRTs), liquid crystal displays (LCDs), or any other type of suitable display. The display 216 generates visual displays of data generated during operation of the device 200. For example, the display 216 may be used to display web pages and/or other content received from a server. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200.

The electrical device 200 may also exchange data with other network devices 222 via a connection to a network. The network connection may be any type of network connection, such as an Ethernet connection, digital subscriber line (DSL), telephone line, coaxial cable, etc. Users of the system may be required to register with a server. In such an instance, each user may choose a user identifier (e.g., e-mail address) and a password which may be required for the activation of services. The user identifier and password may be passed across the network using encryption built into the user's browser. Alternatively, the user identifier and/or password may be assigned by the server.

In some embodiments, the device 200 may be a wireless device. In such an instance, the device 200 may include one or more antennas 224 connected to one or more radio frequency (RF) transceivers 226. The transceiver 226 may include one or more receivers and one or more transmitters. For example, the transceiver 226 may be a cellular transceiver. The transceiver 226 allows the device 200 to exchange signals, such as voice, video and data, with other wireless devices 228, such as a phone, camera, monitor, television, and/or high definition television. For example, the device may send and receive wireless telephone signals, text messages, audio signals and/or video signals.

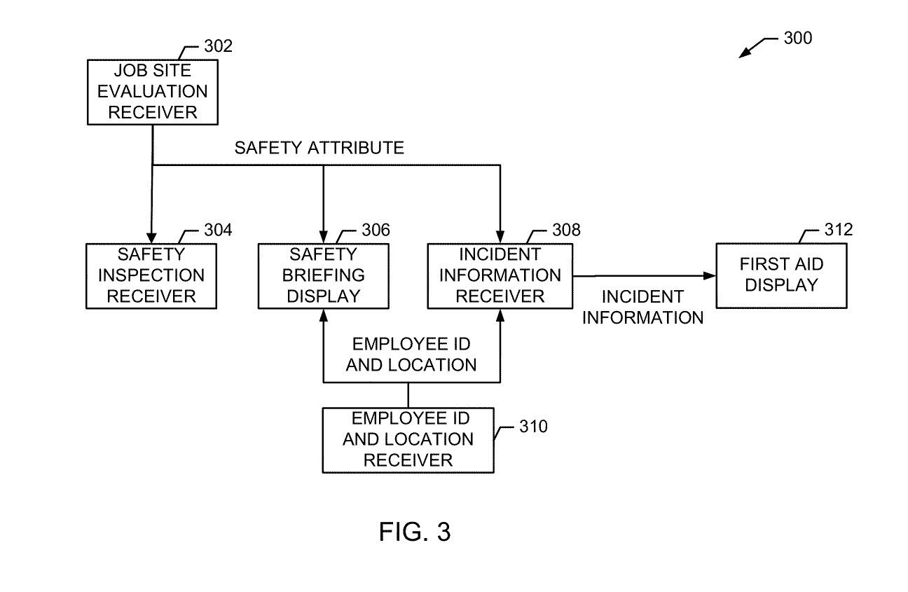

FIG. 3 is a block diagram of an example apparatus for managing safety information. In this example, a job site evaluation receiver 302 receives job site evaluation information including a selection from a user of a job site safety attribute that is associated with the job site. For example, the job site evaluation receiver 302 may receive safety hazard information associated with the job site. In another example, the job site evaluation receiver 302 may receive chemical information, physical information, and/or biological information.

In this example, the job site evaluation receiver 302 passes the job site safety attribute on to a safety inspection receiver 304, a safety briefing display 306, and an incident information receiver 308. The safety inspection receiver 304 receives safety inspection information associated with the job site safety attribute. For example, the safety inspection receiver 304 may receive equipment information associated with the job site safety attribute. In another example, the safety inspection receiver 304 may receive precaution information associated with the job site safety attribute.

In this example, the safety briefing display 306 and the incident information receiver 308 also receive employee identification and employee location information from an employee ID and location receiver 310. For example, the employee ID and location receiver 310 may receive an employee picture, an employee name, an employee identification number, an employee email address, and/or an employee phone number. In another example, the employee ID and location receiver 310 may receive geographical location information selected from a map.

The safety briefing display 306 displays job site safety briefing information associated with the employee identification information and the job site safety attribute. For example, the safety briefing display 306 may display a plurality of safety checklists associated with the job site. In another example, the safety briefing display 306 may display equipment information associated with the job site safety attribute.

The incident information receiver 308 receives incident information associated with the employee identification information and the job site safety attribute. For example, the incident information receiver 308 may receive information associated with the incident via a plurality of checklists. When an incident occurs, a first aid display 312 may display first aid information associated with the incident information.

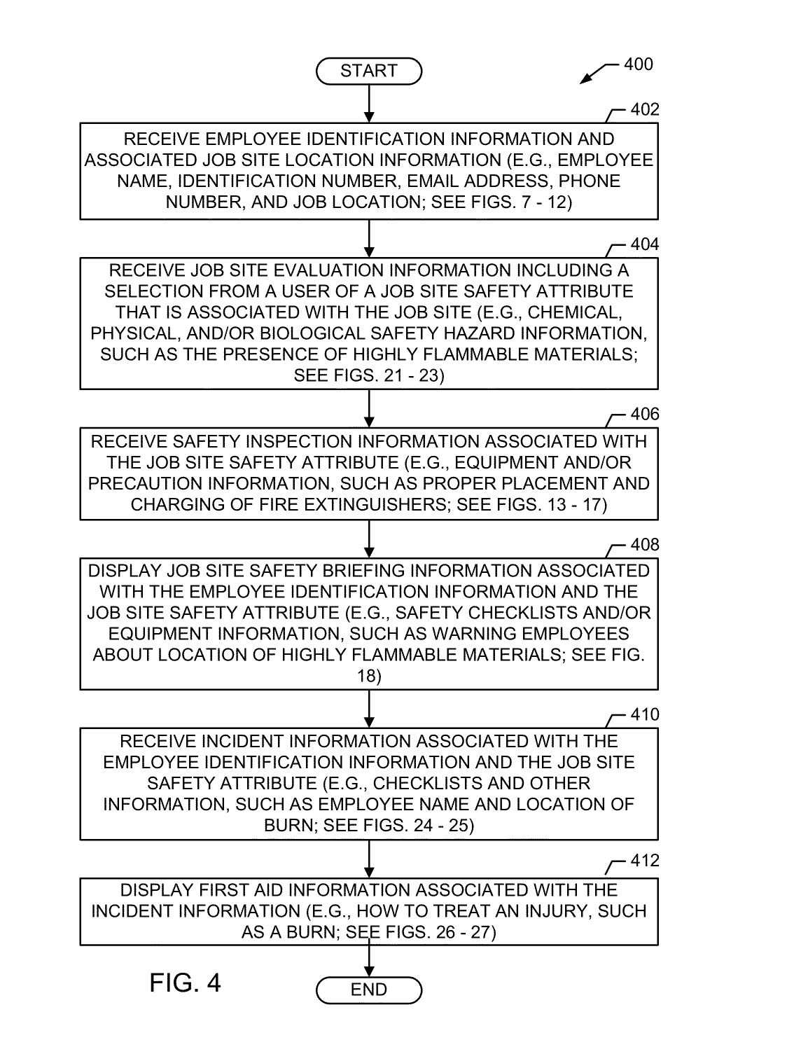

FIG. 4 is a flowchart of an example process 400 for managing safety information. The process 400 may be carried out by one or more suitably programmed processors such as those in block 204 of FIG. 2. Although the process 400 is described with reference to the flowchart illustrated in FIG. 4, it will be appreciated that many other methods of performing the acts associated with process 400 may be used. For example, the order of many of the operations may be changed, and some of the operations described may be optional. The process 400 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware.

In general, a computing device 200, and/or any other suitable device or system, collects and displays information about employees, job locations, job site safety attributes, safety inspections, safety briefings, safety incidents, and first aid. More specifically, the example process 400 begins when a computing device 200, and/or any other suitable device or system, receives employee identification information and associated job site location information (block 402). For example, the computing device 200 may receive an employee picture, an employee name, an employee identification number, an employee email address, and/or an employee phone number. In another example, the computing device 200 may receive geographical location information selected from a map.

The computing device 200 then receives job site evaluation information including a selection from a user of a job site safety attribute that is associated with the job site (block 404). For example, the computing device 200 may receive safety hazard information associated with the job site. In another example, the computing device 200 may receive chemical information, physical information, and/or biological information.

The computing device 200 then receives safety inspection information associated with the job site safety attribute (block 406). For example, the computing device 200 may receive equipment information associated with the job site safety attribute. In another example, the computing device 200 may receive precaution information associated with the job site safety attribute.

The computing device 200 then displays job site safety briefing information associated with the employee identification information and the job site safety attribute (block 408). For example, the computing device 200 may display a plurality of safety checklists associated with the job site. In another example, the computing device 200 may display equipment information associated with the job site safety attribute.

The computing device 200 then receives incident information associated with the employee identification information and the job site safety attribute (block 410). For example, the computing device 200 may receive information associated with the incident via a plurality of checklists. The computing device 200 then displays first aid information associated with the incident information (block 412).

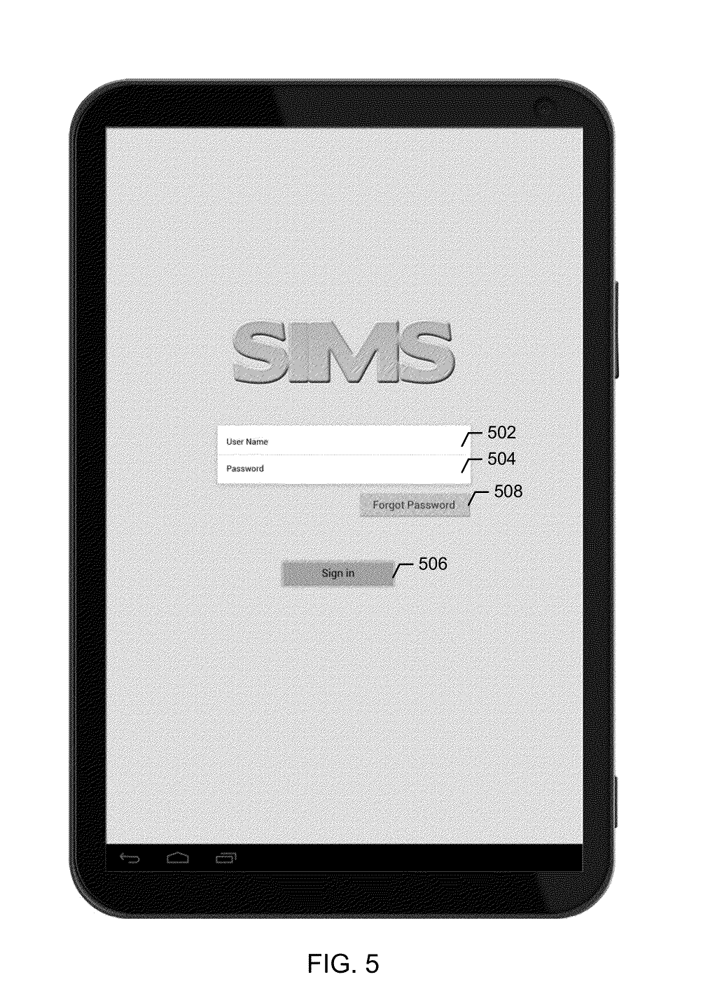

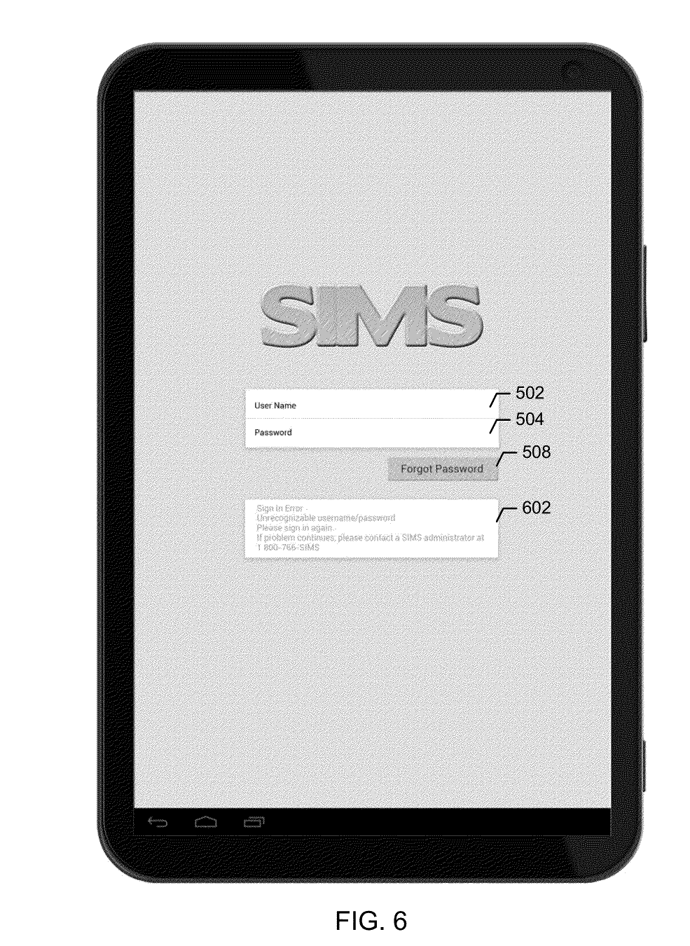

FIGS. 5-6 are example login screens. In this example, a user 114 may enter a user name 502 and a password 504 to sign in 506 to the system. If a sign in error occurs, the user 114 receives an error message 602 as shown in FIG. 6. If the user 114 forgets his/her password, the user 114 may press a forgot password button 508, and the system will email the password or email password reset instructions to the user 114 at the user's email address, which may be the user's user name 502.

FIG. 7 is an example user profile screen. In this example, a user accesses the user profile screen by selecting a user profile button 702. In this example, a personnel area 704 includes a name field, a personnel ID field, a designation field, a region field, a company field, an assigned to field, and a supervisor name field.

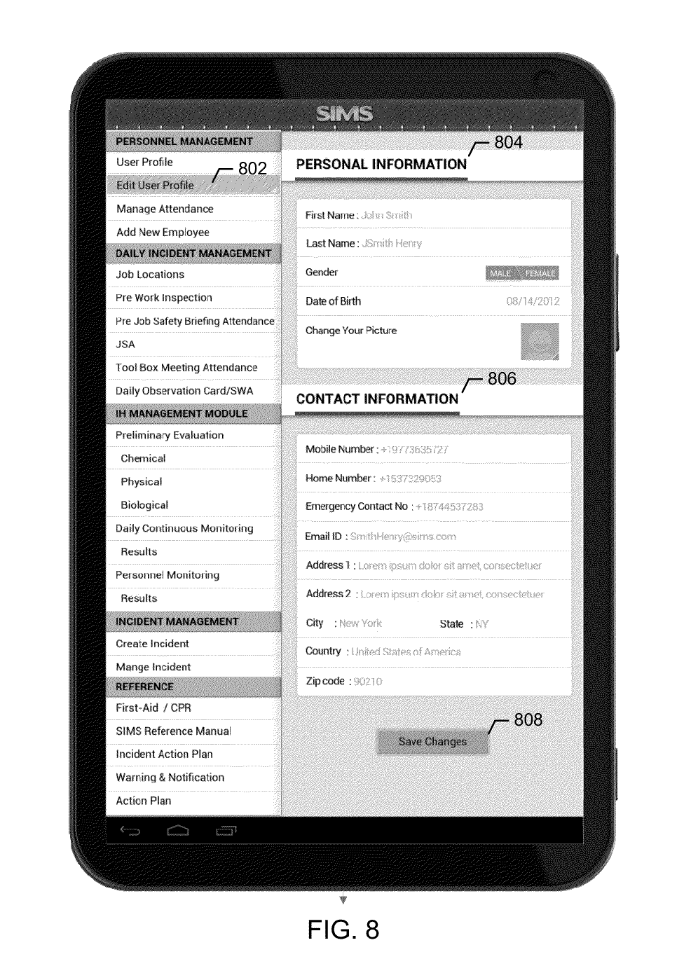

FIG. 8 is an example edit user profile screen. In this example, a user accesses the edit user profile screen by selecting an edit user profile screen button 802. In this example, a personnel information area 804 includes a first name field, a last name field, a gender field, a date of birth field, and a picture field. In this example, a contact information area 806 includes a mobile number field, a home number field, an emergency contact number field, and email ID field, two address fields, a city field, a state field, a country field, and zip code field. In this example, the edit user profile screen includes a save changes button 808 to save any information entered via the edit user profile screen.

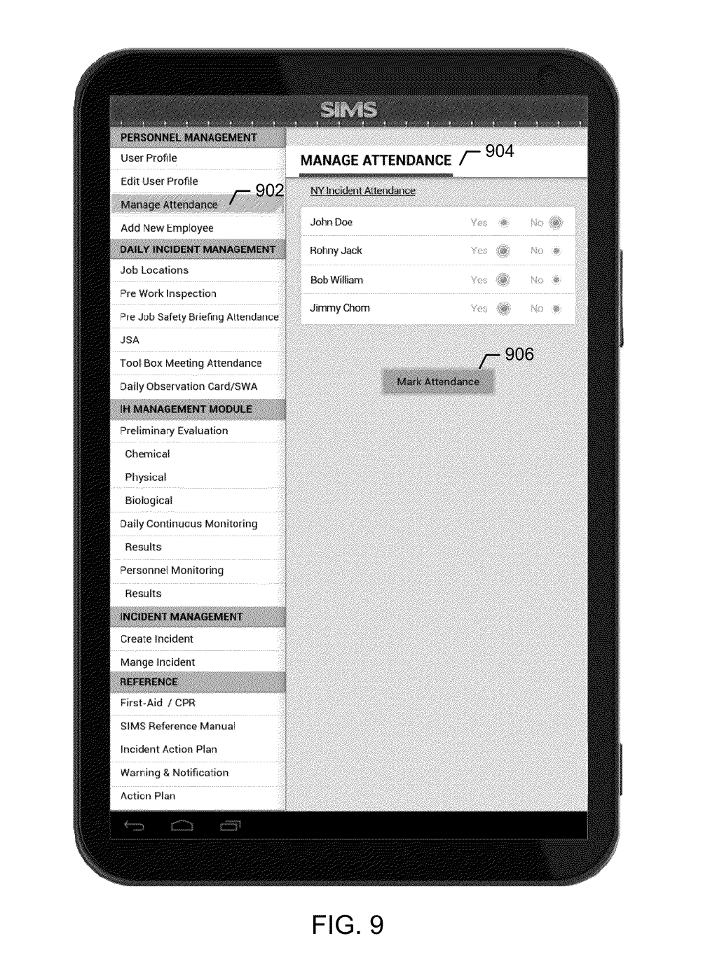

FIG. 9 is an example manage attendance screen. In this example, a user accesses the manage attendance screen by selecting a manage attendance button 902. In this example, a manage attendance area 904 includes a plurality of employee names and associated yes/no radio buttons to indicate which employees attend a particular incident. In this example, the manage attendance screen includes a mark attendance button 906 to save any information entered via the manage attendance screen.

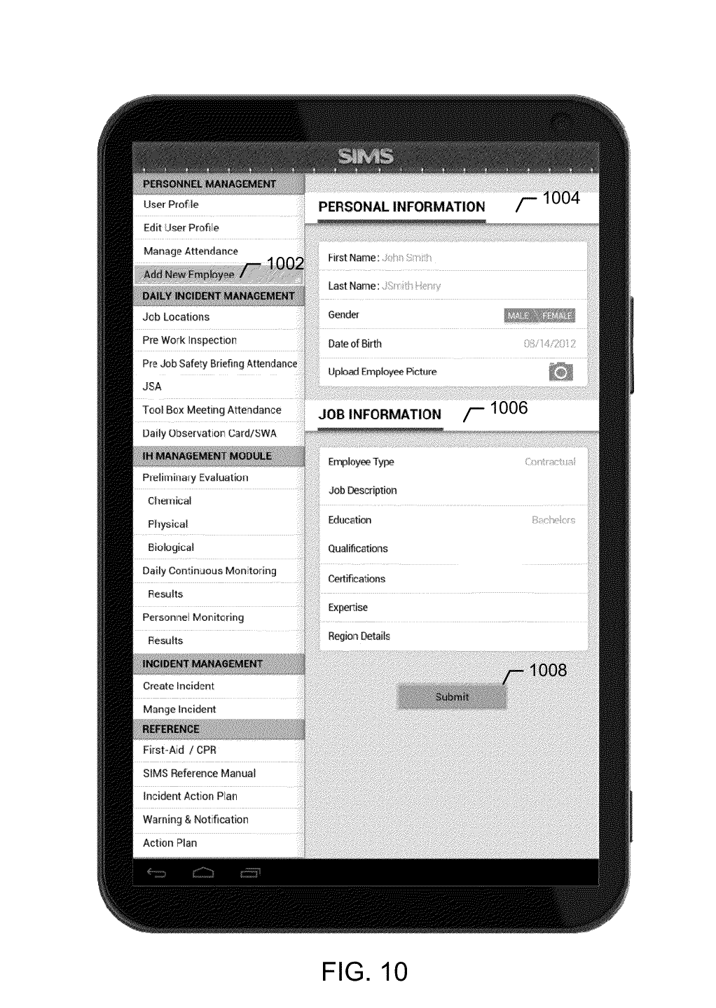

FIG. 10 is an example add new employee screen. In this example, a user accesses the add new employee screen by selecting an add new employee button 1002. In this example, a personal information area 1004 includes a first name field, a last name field, a gender field, a date of birth field, and an upload employee picture field. In this example, a job information area 1006 includes an employee type field, a job description field, a education field, a qualifications field, a certifications field, an expertise field, and a region details field. In this example, the add new employee screen includes a submit button 1008 to save any information entered via the add new employee screen.

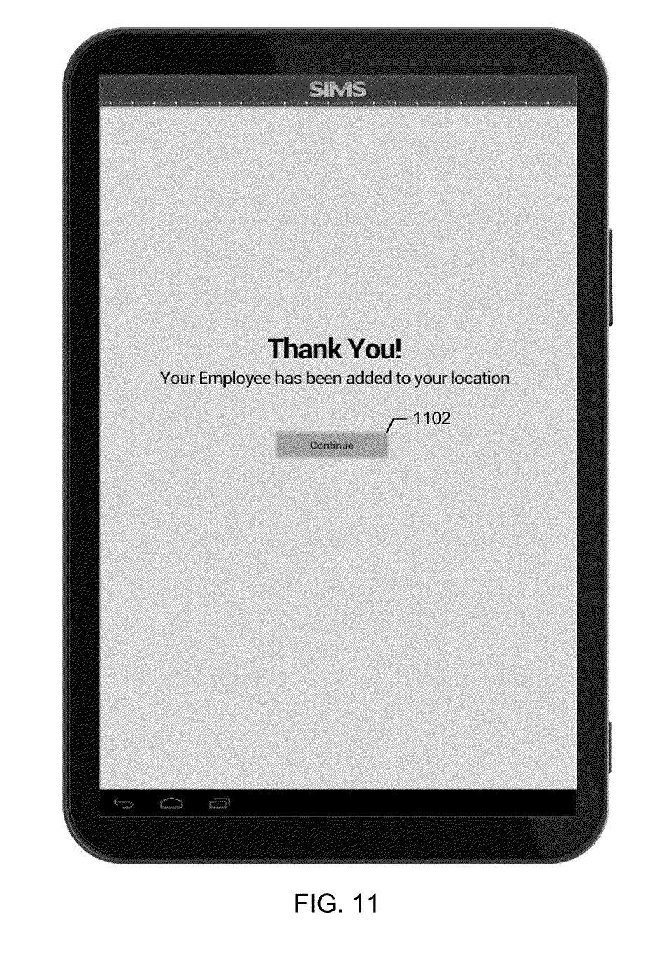

FIG. 11 is an example thank you screen that may be displayed after an employee's information is associated with job location. In this example, the thank you screen includes a continue button 1102 to return to the main screen.

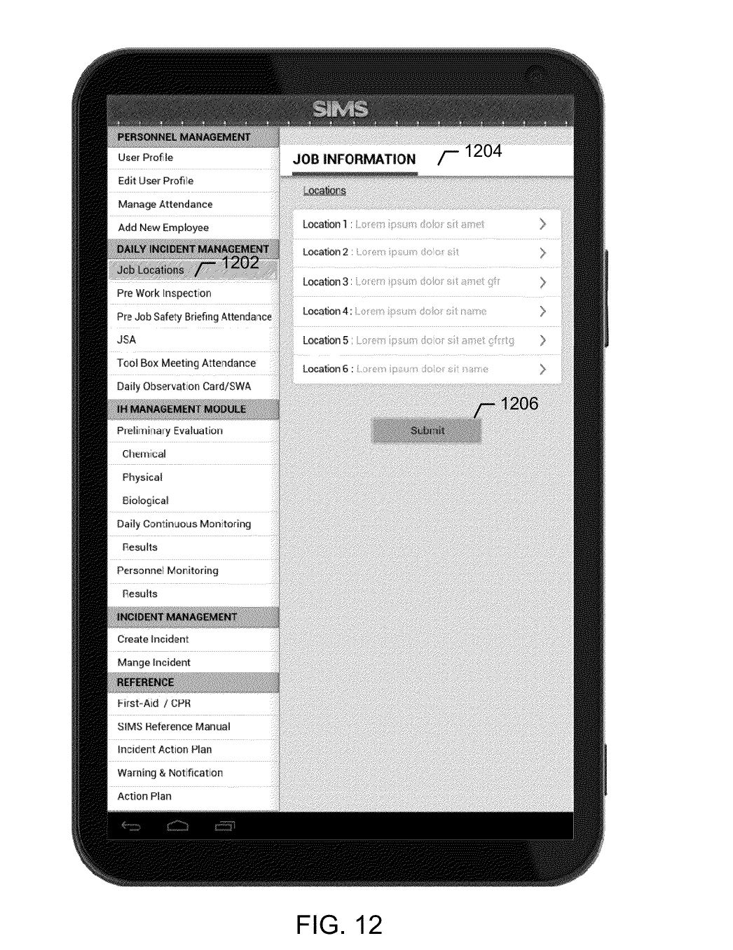

FIG. 12 is an example job locations screen. In this example, a user accesses the job locations screen by selecting a job locations button 1202. In this example, a job information area 1204 includes a plurality selectable job locations and a submit button 1206 to save any information entered via the job locations screen.

FIGS. 13-17 are example pre-work inspection screens. In this example, a user accesses the pre-work inspection screens by selecting a pre-work inspection button 1302. In this example, a pre-work inspection area 1304 includes a job safety inspection report 1402. The example job safety inspection report includes a fire extinguishers present area 1404, an adequate hand rails areas 1406, barricaded holes area 1408, a walkway tripping hazards area 1502, tools and equipment area 1504, a scaffolding area 1506, a ladders area 1602, a rigging techniques area 1604, a condition of rigging equipment area 1606, a handtools area 1702, a housekeeping area 1704, and a personal protective equipment area 1706. Each of these areas includes an okay checkbox, a rating input box, a responsible person input box, a date corrected input box, and an inspected by input box. The example pre-work inspection screen also includes a miscellaneous text input area 1708 and a comments text input area 1710. In this example, the pre-work inspection screen includes a submit button 1712 to save any information entered via the pre-work inspection screen.

FIG. 18 is an example pre-job safety briefing screen. In this example, a user accesses the pre-job safety briefing screen by selecting a pre-job safety briefing button. In this example, a pre-job safety briefing area 1802 includes a plurality of pre-job safety fields. In this example, the pre-job safety briefing screen includes a mark attendance button 1804 to save any information entered via the pre-job safety briefing screen.

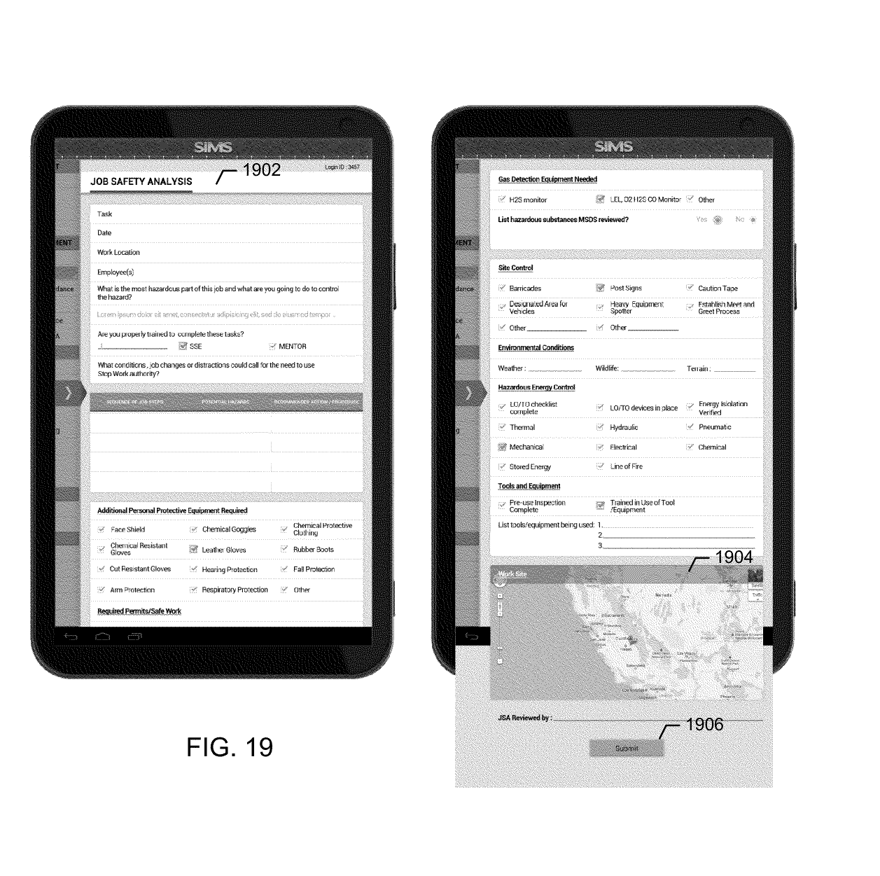

FIG. 19 is an example job safety analysis screen. In this example, a user accesses the job safety analysis screen by selecting a job safety analysis button. In this example, a job safety analysis area 1902 includes a plurality of job safety analysis fields. The example job safety analysis screen also includes work site map 1904, which may be used to display and/or enter a job site location. In this example, the job safety analysis screen includes a submit button 1906 to save any information entered via the job safety analysis screen.

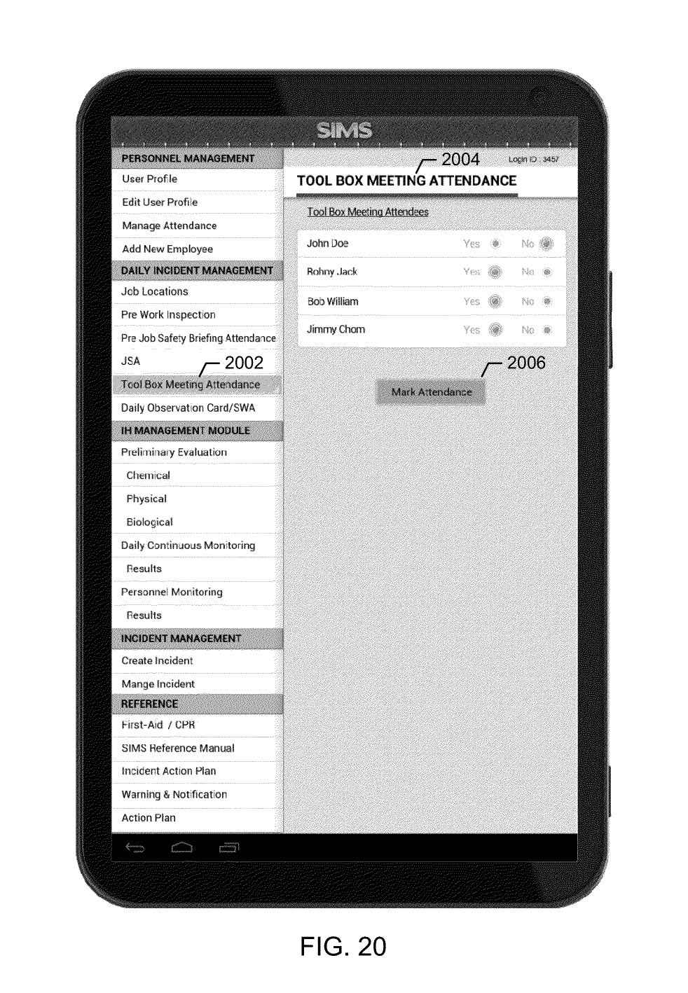

FIG. 20 is an example tool box meeting attendance screen. In this example, a user accesses the tool box meeting attendance screen by selecting a tool box meeting attendance button 2992. In this example, a tool box meeting attendance area 2004 includes a plurality of employee names and associated yes/no radio buttons to indicate which employees attend a particular tool box meeting. In this example, the tool box meeting attendance screen includes a mark attendance button 2006 to save any information entered via the tool box meeting attendance screen.

FIGS. 21-23 are example preliminary site evaluation screens. In this example, a user accesses the preliminary site evaluation screens by selecting a preliminary evaluation button 2102. In this example, a preliminary site evaluation area 2104 includes a preliminary site evaluation form 2202. The example preliminary site evaluation form 2202 includes a chemical hazards area 2204, a physical and equipment hazards area 2206, a biological hazards areas 2302, a health and safety requirements area 2304, a disposal hazards and procedures area 2306, an acute health affect area 2308, a chronic health effects area 2310, a physical effects areas 2312, and a recommended personal protective equipment area 2314. Each of these areas includes a plurality of checkboxes indicating that area was evaluated. Like the other screens, once submitted, the information may be stored and retrieved.

FIG. 24 is an example create incident screen. In this example, a user accesses the create incident by selecting a create incident button 2402. In this example, a create incident area 2404 includes a plurality of incident creation fields. In this example, the create incident screen includes a submit button 2406 to save any information entered via the create incident screen.

FIG. 25 is an example manage incident screen. In this example, a user accesses the manage incident by selecting a manage incident button. In this example, a incident root cause analysis area 2502 includes a plurality of incident management fields. In this example, the manage incident screen includes a submit button 2504 to save any information entered via the manage incident screen.

FIGS. 26-27 are example first aid screens. In this example, a user accesses the first aid screens by selecting a first aid button. In this example, the first aid screens include a first aid guide area 2602, a first aid topics area 2604, an assessing the situation area 2606, a minor first aid situations area 2608, an emergency/trauma situations area 2610, a breathing problems area 2612, a broken bone (fracture) area 2614, a chemical burns area 2616, a choking, airway obstruction area 2618, a penetrating objects area 2702, a poisoning area 2704, a severed body part area 2706, a shock area 2708, a sprains area 2710, a transporting an injured person area 2712, a unconsciousness area 2714, a sever wounds area 2716, and a weather-related situations area 2718.

In summary, persons of ordinary skill in the art will readily appreciate that methods and apparatus for managing safety information have been provided. Among other advantages, the presently disclosed system collects and integrates information for each aspect of job site safety. These aspects include employee identification information, job site location information, job site evaluation information, safety inspection information, job site safety briefing information, safety incident information, and first aid information. The system facilitates incident management of real time data collection and analysis of responder health and safety information during an emergency response. Utilizing the system, site safety representatives can decrease the time gaps in sharing critical data to key incident command personnel, thereby expediting decisions, response plans and ensuring peace of mind for stakeholders. The system may also be used for daily data collection, regulatory reporting and compliance.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of managing safety information, the method comprising:
receiving employee identification information and associated job site location information;
receiving job site evaluation information including a selection from a user of a job site safety attribute that is associated with the job site;
receiving safety inspection information associated with the job site safety attribute;
displaying job site safety briefing information associated with the employee identification information and the job site safety attribute;
receiving incident information associated with the employee identification information and the job site safety attribute; and
displaying first aid information associated with the incident information.

2. The method of claim 1, wherein receiving the employee identification information and associated job site location information includes receiving an employee picture and at least two of an employee name, an employee identification number, an employee email address, and an employee phone number.

3. The method of claim 1, wherein receiving the employee identification information and associated job site location information includes receiving geographical location information selected from a map.

4. The method of claim 1, wherein receiving the job site safety attribute includes receiving safety hazard information associated with the job site.

5. The method of claim 4, wherein receiving the safety hazard information includes receiving chemical information, physical information, and biological information.

6. The method of claim 1, wherein receiving the safety inspection information includes receiving equipment information associated with the job site safety attribute.

7. The method of claim 1, wherein receiving the safety inspection information includes receiving precaution information associated with the job site safety attribute.

8. The method of claim 1, wherein displaying the job site safety briefing information includes displaying a plurality of safety checklists associated with the job site.

9. The method of claim 1, wherein displaying the job site safety briefing information includes displaying equipment information associated with the job site safety attribute.

10. The method of claim 1, wherein receiving the incident information includes displaying a plurality of checklists associated with the incident.

11. The method of claim 1, further comprising generating a report associated with the incident information.

12. An apparatus for managing safety information, the apparatus comprising:
a processor;
an input device operatively coupled to the processor;
a display operatively coupled to the processor; and
a memory device operatively coupled to the processor, the memory device storing a software application, the software application enabling the processor to cause the display to display:
an employee form structured to receive employee identification information and associated job site location information;
a job site evaluation form structured to receive job site evaluation information including a selection from a user of a job site safety attribute that is associated with the job site;
a safety inspection form structured to receive safety inspection information associated with the job site safety attribute;
a job site safety briefing form structured to display job site safety briefing information associated with the employee identification information and the job site safety attribute;
an incident form structured to receive incident information associated with the employee identification information and the job site safety attribute; and
a first aid page structured to display first aid information associated with the incident information.

13. The apparatus of claim 12, wherein the employee form is structured to receive an employee picture and at least two of an employee name, an employee identification number, an employee email address, and an employee phone number.

14. The apparatus of claim 12, wherein the employee form is structured to receive geographical location information selected from a map.

15. The apparatus of claim 12, wherein the job site evaluation form is structured to receive safety hazard information associated with the job site.

16. The apparatus of claim 12, wherein the job site evaluation form is structured to receive chemical information, physical information, and biological information.

17. The apparatus of claim 12, wherein the safety inspection form is structured to receive equipment information associated with the job site safety attribute.

18. The apparatus of claim 12, wherein the safety inspection form is structured to receive precaution information associated with the job site safety attribute.

19. The apparatus of claim 12, wherein the job site safety briefing form is structured to display a plurality of safety checklists associated with the job site.

20. The apparatus of claim 12, wherein the job site safety briefing form is structured to display equipment information associated with the job site safety attribute.

21. The apparatus of claim 12, wherein the incident form is structured to displaying a plurality of checklists associated with the incident.

22. The apparatus of claim 12, further structured to generate a report associated with the incident information.
